(19) United States
(12) Patent Application Publication
(10) Pub. No.: US 2009/0082886 A1
(43) Pub. Date: Mar. 26, 2009

(54) Audio System And Audio Processing Method

(75) Inventors: Yung-Chun Lei, Hsinchu City (TW); Shang-Tzu Ju, Hsinchu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 11/859,169

(22) Filed: Sep. 21, 2007

(51) Int. Cl. G06F 17/00

(52) U.S. Cl. 700/94

(57) ABSTRACT

An audio system and an audio processing method are provided. The audio system comprises a down mixer, an ADC, a storage unit, a control unit, a DSP unit, and a DAC. The down mixer first down-converts an analog signal, which is then converted by the ADC into a first audio digital signal. The storage unit stores a second audio digital signal. The control unit generates a control signal. The DSP unit then processes the first audio digital signal or the second audio digital signal according to the control signal to generate a processed audio digital signal. The DAC converts this processed audio digital signal to a processed analog signal for playback. The audio processing method comprises the steps executed in the audio system.

### CROSS-REFERENCES TO RELATED APPLICATIONS

Not applicable

### BACKGROUND OF THE INVENTION

1. Field of the Invention

The present invention relates to an audio system and audio processing method; in particular, the invention relates to an audio system and audio processing method for processing FM audio data and audio data stored in a storage apparatus.

2. Descriptions of the Related Art

Recently, audio players that enable a user to listen to the radio or audio files on the go have become popular due to their convenience. Generally, an audio player capable of processing FM radio broadcasting and audio files requires two digital signal processing (DSP) units. More particularly, one DSP unit is adapted to process frequency modulation (FM) signals and the other is adapted to process audio signals stored in a storage unit. However, having a structure which comprises two DSP units consumes a large amount of power and occupies a significant amount of space.

As a result, a solution for a circuit board that is smaller and consumes less power in an audio player is urgently required in this field.

### SUMMARY OF THE INVENTION

An objective of this invention is to provide an audio system which comprises a down mixer, an analog to digital converter (ADC), a storage unit, a control unit, a digital signal processing (DSP) unit, and a digital to analog converter (DAC). The down mixer down-converts an analog signal. The ADC converts this down-converted analog signal into a first audio digital signal. The storage unit stores a second audio digital signal. The control unit generates a control signal. The DSP unit then processes the first audio digital signal or the second audio digital signal according to the control signal to generate a processed audio digital signal. Finally, the DAC converts this processed audio digital signal into a processed analog signal for playing.

Another objective of this invention is to provide an audio processing method which comprises the following steps of: down-converting an analog signal; converting the down-converted analog signal into a first audio digital signal; storing a second audio digital signal; generating a control signal; processing the first audio digital signal or the second audio digital signal according to the control signal to generate a processed audio digital signal; and converting the processed audio digital signal into a processed analog signal for playing.

Another object of this invention is to provide an audio system. The audio system comprises: means for down-converting an analog signal; means for converting the down-converted analog signal into a first audio digital signal; means for storing a second audio digital signal; means for generating a control signal; means for processing the first audio digital signal or the second audio digital signal according to the control signal to generate a processed audio digital signal; and means for converting the processed audio digital signal into a processed analog signal for playing.

The present invention adopts a single DSP unit to process two audio digital signals from different sources. Therefore, the dimensions of the audio system are reduced and the power consumption of the audio system is decreased.

The detailed technology and preferred embodiments implemented for the subject invention are described in the following paragraphs accompanying the appended figures for those skilled in this field to well appreciate the features of the claimed invention.

### BRIEF DESCRIPTION OF THE DRAWINGS

FIG. 1 shows a first embodiment in accordance with the present invention; and

FIG. 2 shows a flow chart of a second embodiment in accordance with the present invention.

### DESCRIPTION OF THE PREFERRED EMBODIMENT

In this specification, the term “according to” is defined as “replying to” or “reacting to.” For example, “according to a signal” means “replying to a signal” or “reacting to a signal” without necessity of direct signal reception.

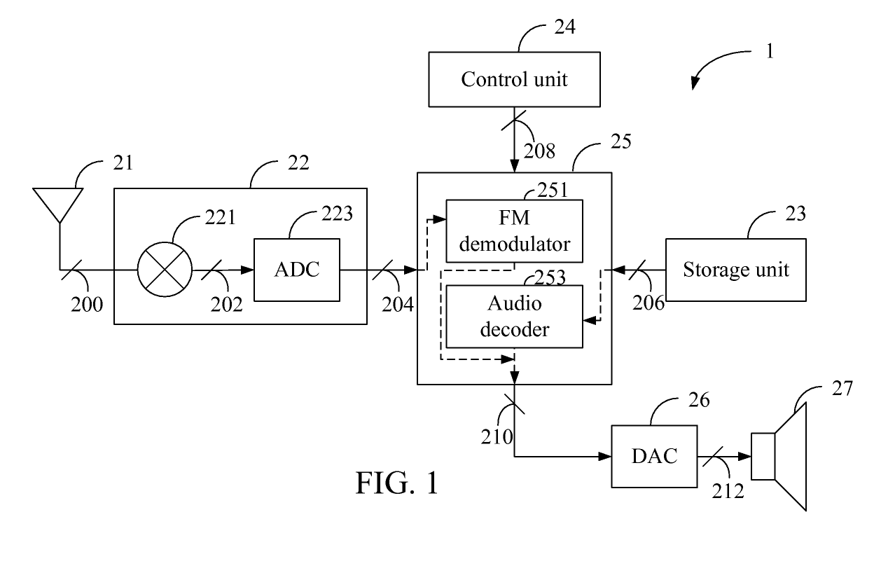

A first embodiment of the present invention is an audio system as shown in FIG. 1. The audio system 1 is able to receive and process two audio signals from two different sources. The audio system 1 comprises an antenna 21, an FM front end 22, a storage unit 23, a control unit 24, a DSP unit 25, a digital-to-analog converter (DAC) 26, and a speaker 27. The FM front end 22 comprises a down mixer 221 and an ADC 223. The DSP unit 25 comprises a FM demodulator 251 and an audio decoder 253. The down mixer 221, the ADC 223, the storage unit 23, the control unit 24, the DSP unit 25, and the DAC 26 may be all embedded in a chip. In other embodiments, the down mixer 221, the ADC 223, the storage unit 23, the control unit 24, the DSP unit 25, and the DAC 26 may be mounted onto a circuit board.

In this embodiment, the audio system 1 is, but not necessarily limited to, a multimedia player for displaying audio data. More particularly, the audio system 1 is CD, VCD, and DVD compatible. In other embodiments, the audio system 1 may be a portable device, such as a mobile phone, a personal media player (PMP), or a personal digital assistant (PDA).

The antenna 21 receives an FM analog signal 200 from a radio station. The down mixer 221 down-converts this FM analog signal 200 and outputs a down-converted FM analog signal 202. The ADC 223 then converts the down-converted FM analog signal 202 to an FM audio digital signal 204. In the first embodiment, the FM audio digital signal 204 is an undemodulated signal. Since the down mixer 221 down-converts the FM analog signal 200, the FM audio digital signal 204 is at an intermediate frequency or a baseband frequency. As those skilled in the art know, the FM audio digital signal 204 may be a serial signal or a parallel signal.

The storage unit 23 pre-stores an audio digital signal 206, such as a MP3 signal. The storage unit 23 may be a hard disk, a compact disk, or a non-volatile memory. The compact disk may be a CD, a VCD, or a DVD. The non-volatile memory may comprise NAND memory or flash memory.

The audio system 1 has two modes. One is an FM mode for playing the FM audio digital signal 204 and the other is a storage playback mode for playing the audio digital signal 206. A user may choose a mode to play either signal by inputting an instruction to the audio system 1. The control unit 24 generates a control signal 208 according to the user's instruction, and the control signal 208 indicates a certain mode selection.

The DSP unit 25 processes one of the FM audio digital signal 204 and the audio digital signal 206 according to the control signal 208. If the FM mode is selected, the FM demodulator 251 demodulates the FM audio digital signal 204 and generates a processed audio digital signal 210. If the storage playback mode is selected, the audio decoder 253 decodes the audio digital signal 206 so that the processed audio digital signal 210 is the signal outputted from the audio decoder 253. The DAC 26 then converts the processed audio digital signal 210 into a processed analog signal 212, and transmits the processed analog signal 212 to the speaker 27 for playing.

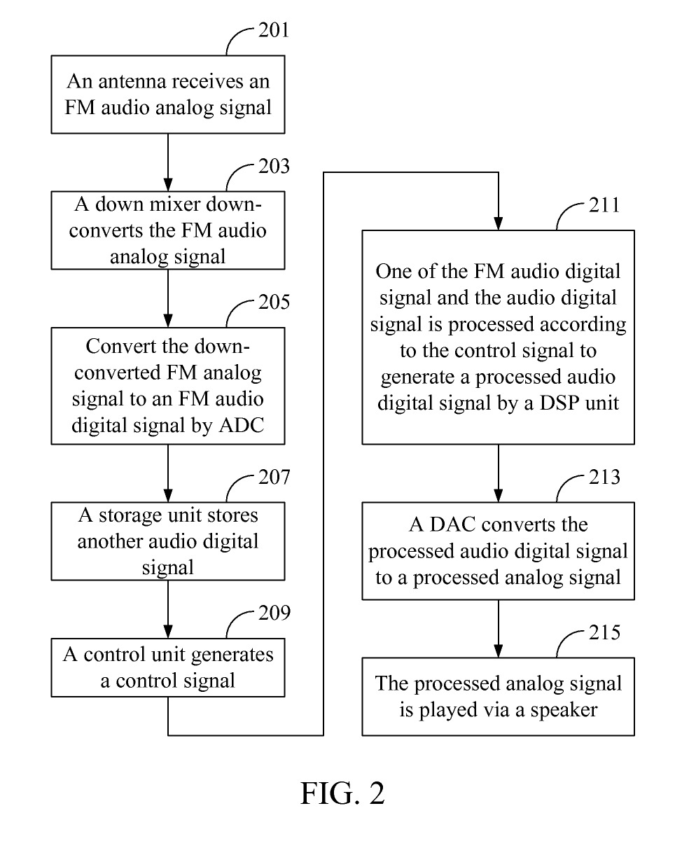

A second embodiment of the present invention is an audio processing method, adapted for an audio system, such as the aforementioned audio system 1. FIG. 2 shows a flow chart of the audio processing method. In step 201, an antenna receives an FM audio analog signal. In step 203, a down mixer down-converts the FM audio analog signal. Step 205 is then executed to convert the down-converted FM analog signal into an FM audio digital signal by an ADC. In step 207, a storage unit stores another audio digital signal. In step 209, a control unit generates a control signal, wherein the control signal is generated according to a user's instruction. Then, either the FM audio digital signal or the audio digital signal is processed according to the control signal to generate a processed audio digital signal by a DSP unit in step 211. Step 213 is then executed in which a DAC converts the processed audio digital signal to a processed analog signal. Finally, the processed analog signal is played via a speaker in step 215. The user may listen to the FM audio digital signal or the audio digital signal thereby.

In addition to the steps shown in FIG. 2, the second embodiment may perform all of the operations and functions recited in the first embodiment. Those skilled in the art are able to realize how the second embodiment performs these operations and functions based on the above descriptions of the first embodiment. Therefore, the descriptions for these operations and functions are redundant and not repeated herein.

The DSP unit of the present invention is capable of executing two signal processing functions, FM demodulation and audio decoding, therefore reducing the size of the audio system. Moreover, the power consumption of the audio system is decreased.

The above disclosure is related to the detailed technical contents and inventive features thereof. Those skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An audio system, comprising:
a down mixer for down-converting an analog signal;
an analog to digital converter (ADC) for converting the down-converted analog signal into a first audio digital signal;
a storage unit for storing a second audio digital signal;
a control unit for generating a control signal;
a digital signal processing (DSP) unit for processing one of the first audio digital signal and the second audio digital signal according to the control signal to generate a processed audio digital signal; and
a digital to analog converter (DAC) for converting the processed audio digital signal to a processed analog signal for playing.

2. The audio system as claimed in claim 1, wherein the first audio digital signal is an undemodulated signal.

3. The audio system as claimed in claim 1, wherein the first audio digital signal is at one of an intermediate frequency and a baseband frequency.

4. The audio system as claimed in claim 1, wherein the control signal indicates a mode selection.

5. The audio system as claimed in claim 4, wherein the mode selection is one of an FM mode associated with the analog signal and a storage playback mode associated with the second audio digital signal.

6. The audio system as claimed in claim 1, wherein the first audio digital signal is one of a serial signal and a parallel signal.

7. The audio system as claimed in claim 1, wherein the DSP unit comprises a FM demodulator for processing the first audio digital signal and an audio decoder for processing the second audio digital signal.

8. The audio system as claimed in claim 1, wherein the storage unit is one of a hard disk, a compact disk, and a non-volatile memory.

9. The audio system as claimed in claim 1, wherein the down mixer, the ADC, the storage unit, the control unit, the DSP unit, and the DAC are all embedded in a chip.

10. The audio system as claimed in claim 1, wherein the audio system is a portable device.

11. The audio system as claimed in claim 1, wherein the audio system is a multimedia player.

12. An audio processing method, comprising:
down-converting an analog signal;
converting the down-converted analog signal into a first audio digital signal;
storing a second audio digital signal;
generating a control signal;
processing one of the first audio digital signal and the second audio digital signal according to the control signal to generate a processed audio digital signal by a DSP unit; and
converting the processed audio digital signal to a processed analog signal for playing.

13. The audio processing method as claimed in claim 12, wherein the first audio digital signal is an undemodulated signal.

14. The audio processing method as claimed in claim 12, wherein the first audio digital signal is at one of an intermediate frequency and a baseband frequency.

15. The audio processing method as claimed in claim 12, wherein the control signal indicates a mode selection.

16. The audio processing method as claimed in claim 15, wherein the mode selection is one of an FM mode associated with the analog signal and a storage playback mode associated with the second audio digital signal.

17. The audio processing method as claimed in claim 12, wherein the first audio digital signal is one of a serial signal and a parallel signal.

18. The audio processing method as claimed in claim 12, wherein the processing step comprises steps of:
demodulating the first audio digital signal; and
decoding the second audio digital signal.

19. The audio processing method m as claimed in claim 12, wherein the second audio digital signal is stored to one of a hard disk, a compact disk, and a non-volatile memory.

20. An audio system, comprising:
means for down-converting an analog signal;
means for converting the down-converted analog signal into a first audio digital signal;
means for storing a second audio digital signal;
means for generating a control signal;
means for processing one of the first audio digital signal and the second audio digital signal according to the control signal to generate a processed audio digital signal; and
means for converting the processed audio digital signal to a processed analog signal for playing.
